(19) United States
(12) Patent Application Publication
(10) Pub. No.: US 2025/0211049 A1
(43) Pub. Date: Jun. 26, 2025

(54) WEDGE FOR RETAINING ROTOR WINDINGS

(71) Applicant: Cummins Generator Technologies Limited, Peterborough (GB)

(72) Inventors: Mark Jason Riley, Peterborough (GB); Anand Odedra, Peterborough (GB); Krzysztof Wejrzanowski, Peterborough (GB); Neil L. Brown, Peterborough (GB); Adrian Edward Bell, Peterborough (GB); Peethamparam Anpalahan, Peterborough (GB)

(73) Assignee: Cummins Generator Technologies Limited, Peterborough (GB)

(21) Appl. No.: 18/848,080

(22) PCT Filed: Mar. 10, 2023
(86) PCT No.: PCT/GB2023/050567

§ 371 Date: Sep. 17, 2024

(30) Foreign Application Priority Data
Mar. 18, 2022 (GB) 2203817.8

(51) Int. Cl. H02K 3/487; H02K 1/26; H02K 15/40

(52) U.S. Cl. CPC H02K 3/487; H02K 1/26; H02K 15/40

(57) ABSTRACT

A rotor for a rotating electrical machine, is disclosed, the rotor comprising a plurality of salient poles (14), rotor windings (16) on the salient poles, and a wedge (40; 60) for retaining the rotor windings of two adjacent poles, the wedge extending partway through the windings in an axial direction. The wedge comprises two legs (42, 44; 62, 64) arranged at an angle to each other. The wedge is configured to be slid axially in the rotor during assembly. This may maximize the space available for axial air flow between adjacent salient poles, while allowing the wedge to have sufficient strength to retain the windings, particularly in machines where higher forces may be developed.

The present invention relates to a wedge for retaining windings on the rotor of a rotating electrical machine, and in particular a wedge which can retain the windings while allowing air flow through the machine. The present invention has particular application in rotating electrical machines of a salient pole design.

Rotating electrical machines, such as motors and generators, comprise a rotor and a stator which are arranged such that a magnetic flux is developed between the two. In a rotating machine of a salient pole design, the rotor has a plurality of poles which extend radially outwards, on which rotor windings are wound. An electrical current flowing in these windings produces a magnetic flux in an airgap between the rotor and the stator. In the case of a generator, when the rotor is rotated by a prime mover, the rotating magnetic field causes an electrical current to be induced in the stator windings, thereby generating the output power. In the case of a motor, an electrical current is supplied to the stator windings and the thus generated magnetic field interacts with that produced by the rotor, causing the rotor to rotate.

In operation, losses may occur due to, for example, resistance in the windings and in losses in the pole body. These losses result in heat being created within the machine. Therefore, many machines include a fan for forcing air flow through the machine to provide cooling. Air flow through the machine is generally in an axial direction. One of the potential paths for air flow is through the rotor between adjacent salient poles. The machine rating is typically determined by the actual temperature rise of the rotor and stator. Therefore, the cooling efficiency of the machine may be an important design consideration.

In a salient pole machine, as the rotor rotates, centrifugal forces develop on the rotor windings, which tends to force the windings outwards in a radial direction. For this reason, many salient pole machines have pole tips which extend circumferentially outwards. The pole tips overlap the rotor windings, and thus retain the windings against the centrifugal forces developed in a radial direction as the rotor rotates.

Forces will also develop on the rotor windings in a circumferential direction. In order to counteract such forces as well as centrifugal forces it is known to provide a wedging arrangement between the windings of adjacent poles. The wedging arrangement is bridged between the pole shoes and presses against the windings on either side on a circumferential direction so as to retain the windings.

One known wedging arrangement comprises two wedge parts each of which abuts a respective winding, and a stud assembly between the two wedge parts. The stud assembly forces the two wedge parts against their respective windings. This arrangement can provide good mechanical retention of the rotor windings. However, this arrangement may partially block airflow through the machine, reducing the amount of cooling that can be achieved. Inserting the wedges into the rotor also takes time since each wedge assembly needs to be tightened into place.

In another known arrangement, a sprung wedge design is used. In this arrangement, the wedge is a single component with two arms arranged at an angle to each other. The wedge has sufficient resilience to allow the two arms to be bent towards each other when a force is applied, and then return upon unloading. In this arrangement, the wedge is inserted in a radial direction into the rotor. When the wedge is in its free state, the angle between the two arms is larger than the angle between two adjacent salient poles. During insertion, the two arms of the wedge are bent towards each other to allow the wedge to pass between the rotor pole tips. When in place, the wedge “springs” back against the rotor windings. Such wedges are therefore sometimes referred to as spring wedges. Spring wedges typically have a smaller cross section which reduces blockage of the air flow. However, the spring wedge design is limited in mechanical performance since the wedge must be sufficiently ductile to compress when being fitted but also sufficiently elastic to spring back against the rotor windings.

It would therefore be desirable to provide a wedge which can minimize blockage of air flow between adjacent poles, while at the same time having sufficient mechanical robustness to retain the rotor windings, particularly in situations where larger forces may be developed such as larger and/or high-speed machines.

According to one aspect of the present invention there is provided a rotor for a rotating electrical machine, the rotor comprising:
a plurality of salient poles;
rotor windings on the salient poles; and
a wedge for retaining the rotor windings of two adjacent salient poles;
wherein the wedge is configured to be slid axially in the rotor during assembly.

The present invention may provide the advantage that, by configuring the wedge to be slid axially in the rotor during assembly, it may be possible to avoid the need for the wedge to bent during assembly. This may allow the wedge to have a design which can maximize the space available for axial air flow between adjacent salient poles, while at the same time having sufficient mechanical strength to retain the windings, particularly in machines where higher forces may be developed on the windings.

The wedge preferably extends partway through the windings in an axial direction. The rotor windings may comprise side windings which extend along the pole in an axial direction, and the wedge may extend partway (but not the whole way) along the side windings. For example, wedge may extend through less than 30%, 25%, 20%, 15% or 10% of the side windings in an axial direction. This may allow part of the windings to be exposed to cooling air.

The wedge may comprise two legs arranged at a (non-zero) angle to each other. This may help to maximize the space available for axial air flow between adjacent salient poles.

The wedge is preferably arranged to be slid axially into place during assembly of the rotor. However, it will be appreciated that, in the assembled machine, the wedge is preferably held in place. This may be achieved, for example, by a friction fitting and/or by impregnating the rotor with resin and/or in any other way.

Preferably the wedge is a single piece. This may simplify manufacture of the wedge and assembly of the rotor and help avoid cost and complexity. For example, the wedge may have an L-shaped cross-section, when viewed in an axial direction.

Preferably the wedge is configured to be inserted axially into the rotor. For example, the wedge may be inserted into the rotor from one end, axially, of the rotor and then slid axially into place. This may avoid the need for the wedge to bend, allowing a stronger wedge to be provided while helping to maximise air flow.

The wedge may have a first leg which abuts rotor windings on a first salient pole and a second leg which abuts rotor windings on a second, adjacent salient pole. The first leg and the second leg may be substantially planar. The first leg and the second leg may be at a (non-zero) angle to each other. The first leg and the second leg may be connected, for example, by a bend. This may allow the wedge to be constructed from a sheet of material, for example a metal such as steel, which may help to reduce part cost and complexity.

Preferably the wedge in its free state has an angle between the first leg and the second leg substantially equivalent to an angle between two adjacent salient poles. For example, in the case of a machine with four salient poles, the first leg and second leg may be substantially at right angles to each other. This may be the case in the free state, during assembly and when assembled on the machine.

The wedge is preferably arranged to have an angle between the first leg and the second leg which is substantially fixed in the free state, during assembly and/or in the assembled rotor. This may avoid the need for the wedge to be elastically deformable, which may allow the wedge to have greater strength than would otherwise be the case.

Preferably an axial cooling channel is defined between the first leg and the second leg. The axial cooling channel may provide an air flow path through the rotor, helping to cool the rotor when the machine is in operation.

Preferably the wedge is of a design which does not include a bracing member (such as a stud assembly) between the first leg and the second leg. This may help to prevent obstruction of air flow through the rotor.

Preferably the wedge is not elastically deformable. Thus, the wedge may be designed such that it cannot be bent to be inserted radially into the rotor and then spring back into place against the rotor windings. For example, the thickness of the wedge, the material from which it is constructed and/or the manufacturing process may be such that the wedge does not have sufficient elastic deformability to be inserted radially into the rotor. This may allow the wedge to be stronger than would otherwise be the case.

Preferably, the wedge is not subjected to a bending moment when the rotor is stationary. It will be appreciated that, when the machine is running, the windings may apply forces including bending moments to the wedge, but the wedge is preferably not subjected to such moments when being fitted or when the rotor is at rest.

The salient poles may comprise pole tips and the wedge may be configured to slide beneath the pole tips of two adjacent poles. In this case, the wedge may have insufficient elastic deformability for it to be inserted radially into the rotor between pole tips of adjacent salient poles. The pole tips may be used to help retain the wedge. For example, the wedge may have one leg which fits (radially) beneath a pole tip on one pole and another leg which fits (radially) beneath a pole tip on an adjacent pole. The pole tips may allow the wedge to be slid axially but may retain the wedge radially.

Preferably a radially inward side of a pole tip is substantially flat. For example, the radially inward side of the pole tip may have a substantially flat surface which is used to retain the rotor windings and to retain the wedge. In this case, the wedge is preferably designed (for example, has sufficient strength) such that it can retain the rotor windings without the need for grooves in the pole tips. For example, the thickness of the wedge may be substantially equal to (for example, greater than 50%, 70%, 80% or 90% and/or less than 150%, 130%, 120% or 110% of) an amount by which the pole tip extends beyond the rotor windings in a circumferential direction. This may help to maximise the number of windings which can be provided on the pole.

In one embodiment, at least one of the pole tips has a recess (in a circumferential direction) which allows a wedge to be inserted radially into the rotor and then slid axially to a position under a pole tip without a recess. This may help to reduce the distance that the wedge needs to be slid along the rotor during assembly.

In one embodiment, the wedge is formed from a bent sheet of material. For example, the wedge may be formed from a sheet of material bent to form a first leg and a second leg. This may facilitate manufacture and provide a cost-effective design.

In one embodiment, the wedge is formed from a metal such as steel. For example, the wedge may be formed from a steel plate, such as hot rolled steel plate. In this case, the steel plate may have a grain which runs in a radial direction. The wedge may be manufactured without heat treatment, which may help to reduce costs. However, if desired, any appropriate material, such as any appropriate metal or any other material could be used instead.

In another embodiment, the wedge is cast or moulded. For example, the wedge may be cast from a material with a relatively low magnetic susceptibility such as aluminium. However, any other material and/or any other manufacturing process (such as machining) could be used as well or instead.

In any of the above embodiments, the wedge may comprise at least one cooling fin, to assist with cooling. At least one cooling fin may be provided on a side of the wedge away from the windings.

The rotor may further comprise a compressible sheet between the wedge and the rotor windings. The compressible sheet may be made, for example, from a textile material, such as felt, or any other suitable material such as a web of plastic material. The compressible sheet is preferably arranged to reduce friction between the wedge and the windings and/or to compensate for variations in a gap between the wedge and the windings. This may facilitate assembly of the wedge on the rotor.

The compressible sheet may be arranged to absorb resin during an impregnation process. When hardened, the resin may help to hold the wedge in position. This arrangement may thus facilitate assembly of wedge to the rotor while helping to ensure that the wedge remains in place in the assembled machine.

In one embodiment, the salient poles comprise winding supports for supporting a radially inward side of the rotor windings. The winding supports may extend outwards from a salient pole into an interpolar space. An axial cooling channel may be defined beneath the winding supports (in a radial direction). The cooling channel may assist in supplying cooling air to the rotor.

A gap may be provided (in a circumferential direction) between the winding supports of two adjacent salient poles. The gap may run through the rotor in an axial direction. The gap may be used to help retain the wedge radially.

The wedge may comprise an extension which extends into a gap between winding supports of two adjacent salient poles. The extension may engage with the winding supports to retain the wedge radially. For example, the extension may extend through the gap between the winding supports and into a channel beneath the winding supports. The extension may comprise a neck which passes through the gap, and a head which is located in the channel. This may allow the wedge to be retained while reducing or avoiding force on the pole tips.

The rotor may comprise a plurality of wedges at spaced locations in an axial direction for retaining the windings of two adjacent poles. Preferably, the rotor windings are at least partially exposed to cooling air in a space between two adjacent wedges. This may help to ensure that the windings are retained throughout the length of the rotor, while allowing some parts of the windings to contact cooling air.

In one embodiment, at least one of the wedges is of a different type from at least one of the other wedges. For example, at least one of the wedges may be of a type which is arranged to be inserted radially into the rotor by compressing two ends of the wedge together. Such a wedge may be for example a spring wedge which is arranged to be inserted radially into the rotor by compressing the two legs together. This may allow a stronger type of wedge to be provided where it is most needed and/or where it is more easily inserted, such as at the ends of the rotor, while allowing another type of wedge to be used elsewhere, such as in locations where it is easier to insert the wedge radially.

According to another aspect of the invention there is provided a rotating electrical machine comprising a stator, a rotor in any of the forms described above, and a fan for drawing air flow through the machine, wherein an axial cooling channel is provided between two adjacent salient poles. The axial cooling channel may be provided between a first leg and a second leg of the wedge.

Corresponding methods may also be provided. Thus, according to another aspect of the invention there is provided a method of assembling a rotor for a rotating electrical machine, the rotor comprising a plurality of salient poles, rotor windings on the salient poles and a wedge for retaining the windings of two adjacent poles, the method comprising sliding the wedge axially in the rotor.

The method may further comprise providing a wedge comprising two legs arranged at an angle to each other, and sliding the wedge axially in the rotor to a position where the wedge extends partway through the windings in an axial direction.

The method may further comprise inserting one or more further wedges between the windings of two adjacent poles. Preferably, the wedges are inserted such that they are spaced apart axially.

The method may further comprise inserting a wedge radially into the rotor through a (circumferential) recess in a pole tip and then sliding the wedge axially to a position under a pole tip without a recess.

Features of one aspect of the invention may be provided with any other aspect. Apparatus features may be provided with method aspects and vice versa.

In the present disclosure, terms such as “radially”, “axially”, “tangentially” and “circumferentially” are generally defined with reference to the axis of rotation of the electrical machine, unless the context implies otherwise.

Preferred embodiments of the present invention will now be described, purely by way of example, with reference to the accompanying drawings, in which:

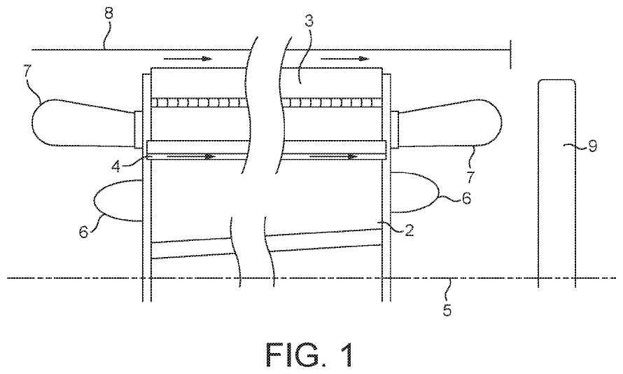

FIG. 1 is a radial cross section through part of a rotating electrical machine;

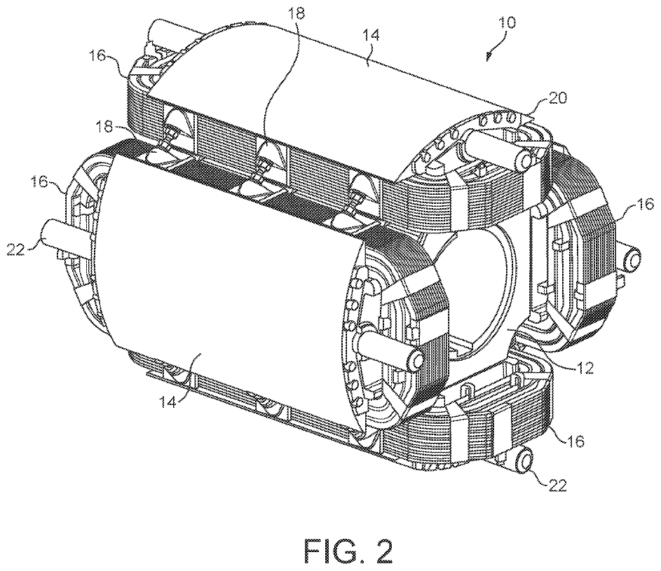

FIG. 2 shows parts of a previously considered rotor;

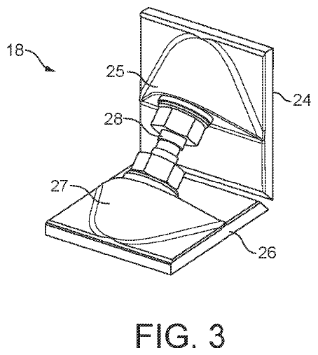

FIG. 3 shows a known retaining wedge;

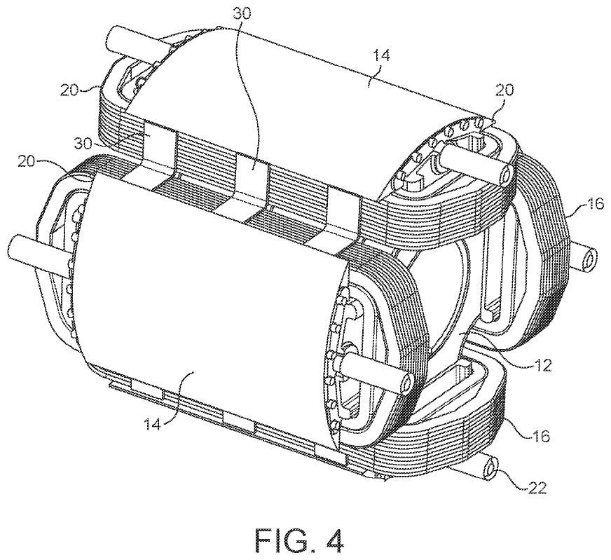

FIG. 4 shows parts of a rotor with another known wedge design;

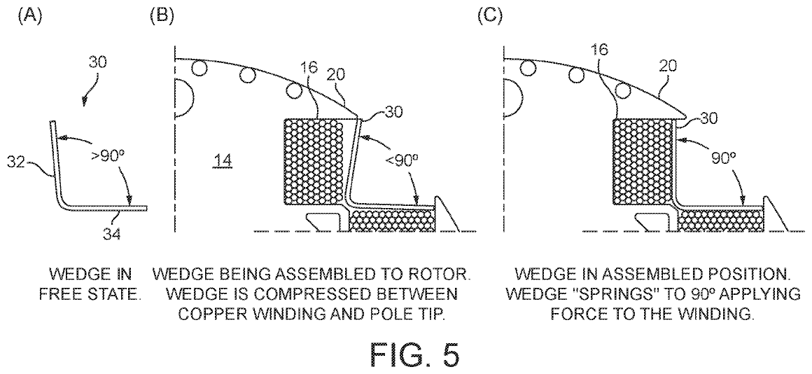

FIGS. 5A to 5C illustrate how the wedge of FIG. 4 is inserted into the rotor;

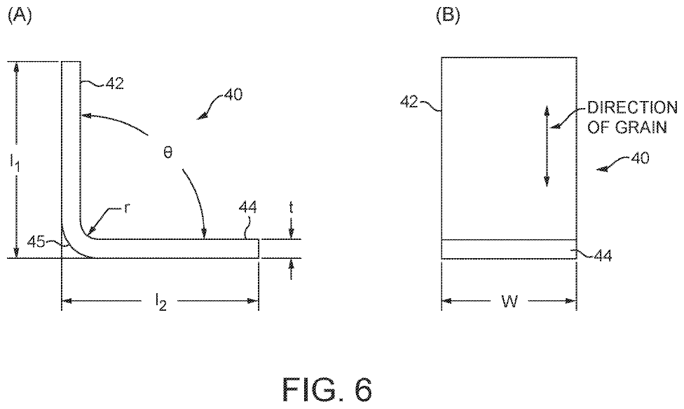

FIGS. 6A and 6B show a side view and an end view of a wedge in an embodiment of the invention;

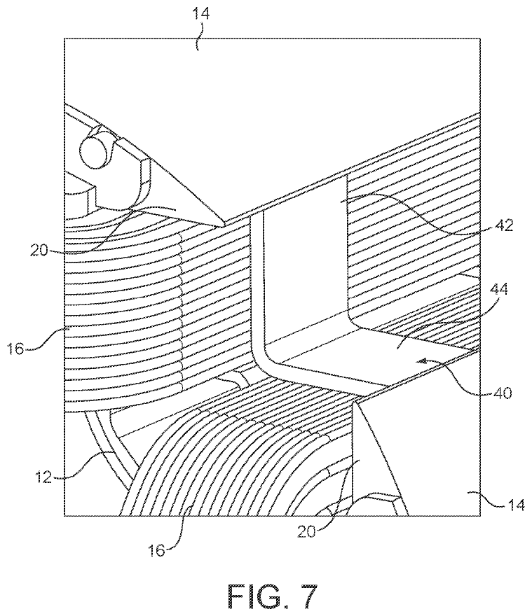

FIG. 7 shows part of a rotor in an embodiment of the invention;

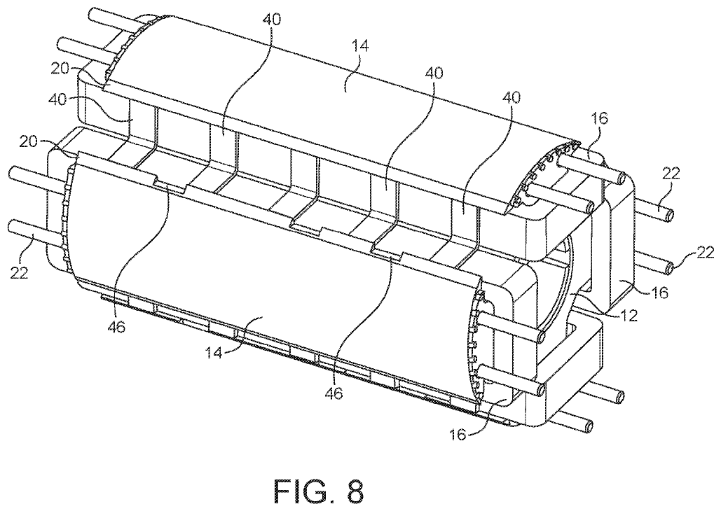

FIG. 8 shows parts of a rotor in another embodiment of the invention;

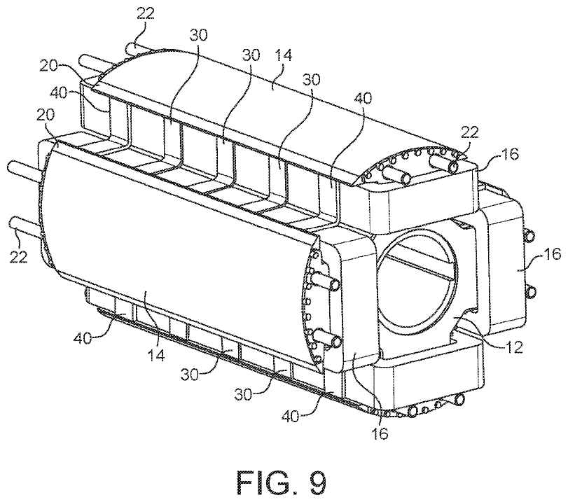

FIG. 9 shows parts of a rotor in another embodiment of the invention;

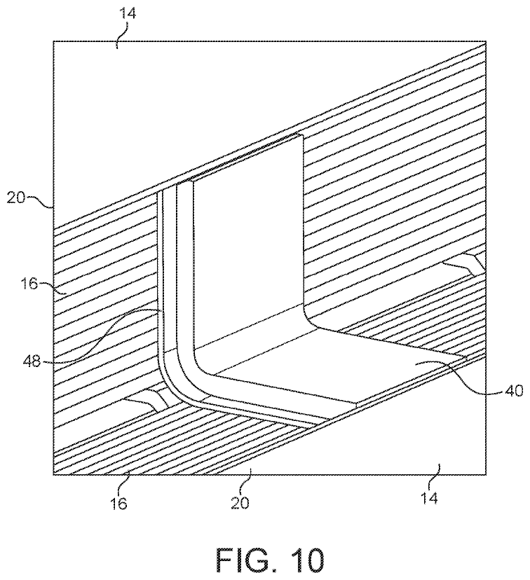

FIG. 10 shows part of a rotor with a plurality of wedges in another embodiment of the invention;

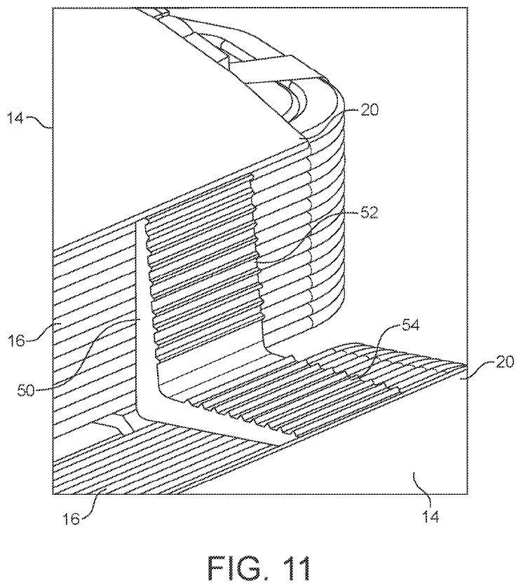

FIG. 11 shows part of a rotor with a plurality of wedges in a further embodiment of the invention; and

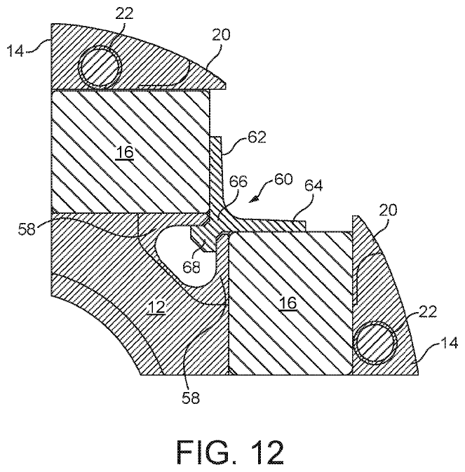

FIG. 12 shows part of a rotor with a slide wedge in another embodiment.

FIG. 1 is a radial cross section through part of a rotating electrical machine. The machine comprises a rotor 2 located inside a stator 3 with an air gap 4 between the two. The rotor 2 is mounted on a shaft with an axis of rotation indicated by the dashed line 5. The rotor 2 is wound with rotor windings 6. The stator 3 comprises a stator core with slots on its inner circumference in which are wound stator windings 7. The stator 3 is contained within a stator frame 8. A shaft-driven fan 9 is located at the drive end of the machine.

In operation, the rotor 2 rotates inside the stator 3. An electrical current flowing in the rotor windings 6 causes a magnetic flux to flow radially across the air gap 4 between the rotor and the stator. The fan 9 is used to draw cooling air in an axial direction through the machine. If desired, an external, independently driven fan or fans or any other appropriate means of forcing air through the machine could be used instead of or as well as a shaft driven fan.

FIG. 2 shows parts of a previously considered rotor for a rotating electrical machine. Referring to FIG. 2, the rotor 10 comprises a rotor core 12 which is formed from a plurality of laminated sheets of metal stacked together to create a rotor of the required axial length. The rotor core 12 comprises a plurality of salient poles 14, each of which extends radially outwards from the centre of the rotor core. Each salient pole is wound with rotor windings 16. The windings 16 are in the form of a coil comprising a conductor such as copper wire which is wound around the pole 14. The windings 16 include side windings which run in a substantially axial direction along the length of the rotor, and end windings which run in a substantially tangential direction around the end of the rotor. Retaining wedges 18 are provided at spaced locations along the side windings. The retaining wedges 18 press against the side windings of two adjacent poles in order to hold the windings in place. The wedges 18 are designed to retain the rotor windings 16 against centrifugal and other forces while the machine is in operation. The salient poles 14 include pole tips 20 which extend circumferentially on either side of the pole at the radially outermost end. The pole tips 20 help to support the rotor windings 16 against the forces which are developed during operation of the machine. The retaining wedges 18 are held in place in part by the pole tips 20, and in part by frictional forces between the wedges and the windings. Rotor winding support bars 22 are also provided. The rotor winding support bars 22 run in an axial direction through the rotor and extend outwards at each end of the rotor in order to support the end windings. In this example the rotor has four poles, although other machines may have a different number of poles.

FIG. 3 shows in more detail a retaining wedge of the type used in the rotor of FIG. 2. Referring to FIG. 3, the wedge 18 comprises a first wedge member 24, a second wedge member 26, and a stud assembly 28. The first wedge member 24 and second wedge member 26 each has an outer surface which is designed to abut rotor side windings on a respective rotor pole. Wedge-shaped protrusions 25, 27 are provided on the inner surfaces of the wedge members (the surfaces which face each other). The wedge-shaped protrusions 25, 27 extend circumferentially inwards and engage with the stud assembly. The stud assembly 28 comprises a stud, nuts and washers. In the assembled rotor, the stud assembly 28 is in compression and pushes apart the first wedge member 24 and the second wedge member 26, causing them to press against their respective windings. The first wedge member and the second wedge member are typically formed from cast aluminium.

It has been found that the retaining wedge assembly of FIG. 3 can provide good mechanical retention of the rotor windings. However, due to the size and shape of the wedge members and the stud assembly, they may restrict axial air flow through the rotor. Reducing this restriction would increase air flow and improve cooling of the rotor windings. Inserting the wedge assemblies into the rotor also takes some time since each stud assembly needs to be tightened individually.

FIG. 4 shows parts of a rotor with another known wedge design. Referring to FIG. 4, the rotor comprises a rotor core 12 with a plurality of salient poles 14 and rotor windings 16, which may be substantially in the form described above. A plurality of wedges 30 are provided between the side windings of adjacent poles. Each wedge 30 comprises a single piece of material such as steel bent to form a first leg and a second leg. Each leg has an outer surface which is designed to abut rotor windings in a respective rotor pole. The wedges 30 are held in place in part by the pole tips 20, and in part by frictional forces between the wedges and the windings. In this arrangement, the wedges 30 are L-shaped “spring” wedges that are subjected to a bending moment during insertion and when in place. The wedge design of FIG. 4 may be used in smaller machines where lower forces are developed.

FIGS. 5A to 5C illustrate how the wedge 30 of FIG. 4 is inserted into the rotor. FIG. 5A shows the wedge 30 in its free state, before insertion. Referring to FIG. 5A, the wedge comprises a first leg 32 and a second leg 34 which are at an angle to each other. In this state, the angle between the first leg 32 and the second leg 34 of the wedge is greater than 90°.

FIG. 5B shows the wedge 30 during insertion into the rotor. As the wedge 30 is inserted, the two legs 32, 34 of the wedge are pressed towards each other. The angle between the two legs reduces to less than 90° as the wedge passes radially through the smallest gap between the rotor windings and the opposite pole tip. At this point the wedge is subjected to high assembly stresses due to bending.

FIG. 5C shows the wedge 30 after insertion. The wedge retains sufficient elasticity to “spring” into its final fitted position. The angle of the wedge when fitted is approximately 90°. The wedge 30 applies a small load to the rotor windings which prevents the wedge from moving axially during subsequent manufacturing processes. To ensure the wedge 30 does not crack during insertion and remains elastic, the thickness of the wedge is limited. The steel grade and hardness of the wedge are controlled so that the yield strength of the steel is sufficiently high.

The “spring” wedge design of FIGS. 4 and 5 is smaller in cross section than the cast aluminium wedges of FIGS. 2 and 3, and so provides less restriction to air flow. However, the spring wedge design is limited in mechanical performance since the wedge must be sufficiently ductile to compress when being fitted, but also sufficiently elastic to “spring” back against the rotor winding. With these mechanical constraints it has been found that the spring wedge is an option in smaller machines. However, larger or faster rotors may need a more robust wedge.

FIGS. 6A and 6B show respectively a side view and an end view of a wedge in an embodiment of the invention. The wedge in this embodiment is designed to have a small cross section, comparable to that of a spring wedge, but without its mechanical restrictions. The wedge is an “L” shape wedge similar in appearance to the spring wedge but is at a fixed 90° angle in its free state and when assembled to the rotor.

Referring to FIGS. 6A and 6B, the wedge 40 in this embodiment comprises an “L” shaped piece of material with a first leg 42 and a second leg 44. The legs 42, 44 are substantially planar, and are joined by a bend 45 with an inner radius r. Each leg 42, 44 has an outer surface which is designed to abut rotor windings in a respective rotor pole. The inner surfaces (the surfaces facing each other) are substantially flat. The wedge 40 has a length I₁ in the direction of the first leg 42 and a length 12 in the direction of the second leg 44. The lengths I₁ and 12 are roughly equal and correspond approximately to the distance between the outside of the windings on one pole and the inside of the pole tip on the adjacent pole. The legs 42, 44 are arranged at an angle θ to each other. The wedge is designed not to be elastically deformable, and thus the angle θ remains substantially constant when the wedge is in its free state, during insertion and in the assembled rotor. In this embodiment, the angle θ between the first leg 42 and the second leg 44 is 90° (within margins of tolerance) which corresponds to the angle between two adjacent salient poles in a four-pole machine. The wedge 40 has a thickness t which is substantially constant. The thickness t and the width w of the wedge, as well as the material and the manufacturing process, are chosen to give the wedge sufficient strength to retain the rotor windings, while allowing maximum air flow through the machine.

The wedge 40 may be manufactured from any suitable material such as hot rolled steel plate. In this case, the grain of the steel is in a radial direction (the direction of the legs 42, 44 away from the bend 45). This helps to provide the wedge with the necessary strength to retain the rotor windings.

To assemble the wedge 40 of FIGS. 6A and 6B, the wedge is inserted axially into the rotor from one end and then slid axially along the rotor, instead of being inserted radially between the pole tips. This wedge may therefore be referred to as a “slide” wedge. Since the wedge does not need to be elastically deformable, the thickness t of the wedge can be larger than would be the case for a spring wedge.

FIG. 7 shows part of a rotor with a slide wedge in one embodiment. Referring to FIG. 7, the rotor comprises a rotor core 12 with a plurality of salient poles 14 and rotor windings 16, which may be substantially in the form described above. A wedge 40 is provided between two adjacent salient poles 14, in order to retain the rotor windings 16. The wedge 40 comprises a first leg 42 and a second leg 44. The first leg 42 sits beneath (in a radial direction) a pole tip 20 of one pole and the second leg 44 sits beneath the pole tip 20 of an adjacent pole. The (radially outwards) ends of the legs 42, 44 abut, or are in close proximity to, the pole tips 20. The radially inwards sides of the pole tips are substantially flat and extend in a generally tangential direction.

Although for simplicity a single wedge is shown, a plurality of wedges 40 may be provided at spaced locations in an axial direction through the rotor, and between each pair of adjacent salient poles. If desired, insulation paper (not shown) may be provided between the wedge 40 and the windings 16.

During assembly, the wedge 40 is inserted into the rotor from one end, axially, and then slid axially along the rotor with each leg 42, 44 under a respective pole tip 20. During insertion, the rotor windings 16 may need to be held back against the poles 14 by tooling as the slide wedge 40 is inserted axially. This is because the windings may bulge out from the poles prior to the wedges being fitted.

When in place, the wedge 40 is retained radially by the pole tips 20. This is achieved by virtue of the fact that the gap between two adjacent pole tips decreases with increasing radial distance. Thus, the wedge 40 is retained without the need for grooves or other retaining means in the pole tips. The thickness of the wedge 40 corresponds substantially to the amount by which a pole tip 20 extends past the rotor windings 16.

When comparing the spring wedge of FIGS. 4 and 5 with the “slide” wedge of FIGS. 6 and 7, assuming a similar rotor design, the following differences can be noted:
The slide wedge 40 has an angle θ between the two legs 42, 44 which is fixed in its free state, during assembly and when assembled to the rotor.
The slide wedge 40 is not in bending moment against the rotor windings.
The thickness t of the slide wedge 40 can be greater than that of the spring wedge.
The lengths I₁ and 12 of the legs 42, 44 in the slide wedge may be slightly less than those of the spring wedge, to provide clearance for the slide wedge to slide under the pole tips.

The slide wedge design of FIGS. 6 and 7 may provide the following features and advantages:
Reduced restriction to air flow compared with standard rotor wedge assemblies.
The thickness of the wedge can be increased compared to the spring wedge since the wedge is not compressed during insertion (zero assembly stress).
The thicker wedge increases the mechanical retention of the rotor windings and allows the wedge to be used on larger rotor sizes.
More readily available materials such as common steel grades may be used for manufacturing of the wedge, and it may be possible to avoid the need for controlled heat treatment. This may reduce part cost.

FIG. 8 shows parts of a rotor in another embodiment. Referring to FIG. 8, the rotor comprises a rotor core 12 with a plurality of salient poles 14 and rotor windings 16 which may be substantially in the form described above. In this embodiment each salient pole 14 has two support bars 22 to support the rotor end windings. A plurality of wedges 40 are provided between two adjacent rotor poles to retain the side windings. The wedges 40 are of the type described above with reference to FIGS. 6 and 7. The wedges 40 between two adjacent poles are located at spaced locations in an axial direction through the rotor. During assembly, each wedge is slid axially into place. The wedges 40 are located under the pole tips 20 of two adjacent salient poles 14.

In the arrangement of FIG. 8, the pole tips 20 on one side of a pole 14 have a plurality of recesses 46. The recesses may be formed by removing part of the pole tip from some of the rotor laminations prior to assembly. The recesses have a length in an axial direction which is slightly larger than the width w of a wedge. The recesses 46 allow a wedge 40 to be inserted radially into the rotor through the gap created by a recess. The wedge is then slid axially along the rotor so that it is under a part of the pole tip where there is no recess.

By providing a rotor with recesses 46 in the pole tip in the manner shown in FIG. 8, the distance that the wedges need to be slid along the core can be reduced, which may facilitate assembly and help avoid damage to the windings.

In the arrangement of FIG. 8, three recesses 46 are shown at spaced locations along the rotor in an axial direction. However, it will be appreciated that any appropriate number of recesses (for example, one, two, three, four or more) could be provided at any appropriate location. Recesses may be provided in either or both of the pole tips in adjacent poles.

FIG. 9 shows parts of a rotor in another embodiment. Referring to FIG. 9, the rotor comprises a rotor core 12 with a plurality of salient poles 14 and rotor windings 16 which may be in the form described above. Each salient pole 14 has two support bars 22 to support the rotor end windings. A plurality of wedges 30, 40 are provided between two adjacent rotor poles to retain the side windings. Each of the wedges 30, 40 is held in place by the pole tips 20.

In this embodiment, a combination of slide wedges 40 and spring wedges 30 is used. A slide wedge 40 is provided between two adjacent poles at each end of the rotor axially. A plurality of spring wedges 30 are provided between two adjacent poles at intermediate positions between the two ends. During assembly, each of the slide wedges 40 is inserted axially into the rotor from a respective end of the rotor, and slid axially into place. Each of the spring wedges 30 is inserted radially into the rotor, using the techniques described above with reference to FIGS. 5A to 5C.

Due to the movement of the rotor end windings, the wedges at the ends of the rotor core may be subjected to higher loads compared with the wedges in the centre of the rotor core. Having more robust slide wedges at the ends of the rotor core may allow less mechanically robust spring wedges to be used in the centre of the core. The spring wedges may be easier to insert in the centre of the core, with the slide wedges only needing to be slid a short distance from the core ends.

It will be appreciated that any appropriate combination of slide wedges and spring wedges could be used. For example, two slide wedges could be provided at each end of the rotor, or slide wedges could be alternated with spring wedges, or any other combination.

FIG. 10 shows part of a rotor with another embodiment of a slide wedge. Referring to FIG. 10, the rotor comprises a wedge 40 which is slid axially into place between two adjacent salient poles in a similar way to the slide wedges described above. However, in this embodiment, the slide wedge 40 has additional clearance between the wedge and the rotor windings 16 to help slide the wedge into position. A compressible sheet 48 is used between the wedge 40 and the windings 16 to fill the gap. The compressible sheet 48 may be made from a textile material, such as felt, or some other material such as a plastic. The compressible sheet 48 reduces the friction between the wedge 40 and the windings 16 and facilitates sliding of the wedge without damaging the windings. The compressible sheet 48 also helps to absorb any variations in the gap between the wedge 40 and the windings 16. However, the compressible sheet 48 preferably absorbs resin during a subsequent impregnation process. When the resin has hardened, this helps to lock the wedge in position.

In the embodiments described above, the wedge 40 may be manufactured from any suitable material such as hot rolled steel plate. For example, it has been found that common steel grade may be used without heat treatment, which may help to reduce part cost and complexity. The direction of the grain is preferably in a radial direction rather than an axial direction, to help the wedge retain its shape. If desired, a coating may be applied to the wedge to reduce friction and/or provide electrical insulation.

While the use of steel wedges may help to reduce cost and complexity, in some circumstances there may be a risk of flux leakage through the steel. In alternative embodiments, this may be prevented by using wedges manufactured from a material with a lower magnetic susceptibility such as aluminium. The aluminium wedges may be manufactured, for example, using a casting process.

FIG. 11 shows part of a rotor with another embodiment of a slide wedge. Referring to FIG. 11, the rotor comprises a wedge 50 which is slid axially into place between two adjacent salient poles in a similar way to the slide wedges described above. In this embodiment, the slide wedge 50 is made from aluminium, and may be manufactured using a casting process. The wedge 50 is “L” shaped with a first leg 52 and a second leg 54. Each leg 52, 54 has an outer surface which abuts the windings 16 on a respective rotor pole 14. The outer surfaces of the two legs 52, 54 have an angle between them of 90°. However, each leg 52, 54 has a thickness which reduces from the centre of the wedge towards the ends. This allows the strength of the wedge to be increased at the point of maximum stress.

In this embodiment, a plurality of cooling fins are provided on the inner surfaces of each leg 52, 54. The fins may be formed during the casting process, or may be machined after the wedge has been cast. The cooling fins help with cooling of the rotor windings when the machine is in use.

Although in this embodiment the wedge 50 is cast from aluminium, any appropriate material, such as another metal or a plastic material may be used instead or as well, and any appropriate manufacturing process may be used.

FIG. 12 shows part of a rotor with a slide wedge in another embodiment. Referring to FIG. 12, the rotor comprises a rotor core 12 with a plurality of salient poles 14 and rotor windings 16, which may be substantially in the form described above. As in previous embodiments, the salient poles 14 include pole tips 20 which help to support the rotor windings 16 against centrifugal and other forces. However, in this embodiment, the salient poles 14 include winding supports 58 beneath the windings 16. The winding supports 58 are located on both sides of the salient poles 14 and extend from the salient poles into the interpolar space between two adjacent poles. Each winding support 58 is located directly beneath (radially inwards) of the rotor windings 16 of that pole, in order to support the windings in a radial direction. The radially inward sides of the winding supports 58 are open, and form axial channels through the rotor. The axial channels allow cooling air to pass beneath the winding supports. In this embodiment the winding supports 58 are integral with the salient poles and may be formed as part of a stamping process when the rotor laminations are manufactured.

In the arrangement of FIG. 12, the winding supports 58 extend across substantially the whole depth of the windings 16 in a generally circumferential direction. However, a gap is left between the end (circumferentially) of a winding support of one pole and that of the adjacent pole which extends into the same interpolar space. The gap is used to help retain rotor wedges.

Still referring to FIG. 12, a wedge 60 is provided between two adjacent salient poles 14, in order to retain the rotor windings 16 in a circumferential direction. The wedge 60 is L-shaped with a first leg 62 and a second leg 64 at an angle to each other. The legs 62, 64 are substantially planar, and are joined by a bend, in a similar way to the wedges described above. However, in this embodiment, the wedge includes an extension which extends radially inwards from the bend. The extension extends through the gap between the ends of the winding supports 58 of two adjacent poles. The extension comprises a neck 66 and a head 68. The neck 66 has a width (in a circumferential direction) which smaller than the gap between the ends of the winding supports 58. The neck 66 extends through this gap and into the axial channel beneath the winding supports. However, the head 68 has width which is larger than the gap. Thus, the head 68 is not able to pass through the gap in a radial direction. The head 68 is located in the axial channel beneath the winding supports 58. In this embodiment, the head 68 engages with the winding supports 58 in order to hold the wedge in place.

During assembly, the wedge 60 is inserted into the rotor from one end, axially, with the head 68 in the axial channel beneath the winding supports 58. The wedge is then slid axially along the rotor with each leg 62, 64 against a respective rotor winding 16. As the wedge is slid axially, the head 68 slides through the axial channel. Once the wedge is in position, the winding supports 58 and the head 68 retain the wedge radially. A plurality of wedges are provided at spaced locations axially through the rotor. Each of the wedges may be the same or different.

The arrangement of FIG. 12 can allow the wedge to be held in place without applying a force to the pole tips. This may allow the pole tips to be smaller than would otherwise be the case and/or additional space to be provided for rotor windings. This in turn may help to improve the power density and/or peak efficiency of the machine.

In the arrangement shown, the legs 62, 64 extend part way across the rotor windings 16 in a radial direction, but not as far as the pole tips 20. However, if desired, the legs 62, 64 could extend as far as the pole tips 20, or some other distance across the windings.

In an alternative embodiment, a tapped bar is provided in the axial channel beneath the winding supports, and a bolt passes through a hole in the wedge, through the gap between the ends of the winding supports 58 and into the tapped bar. The tapped bar and the wedge, and optionally the bolt, may be slid axially into position. When in position, the bolt may be tightened to draw the wedge towards the tapped bar and thus the winding supports. This arrangement can help to retain the wedge radially and may also help prevent axial movement once the bolt is tightened.

In a further embodiment, an arrangement comprising a tapped bar and bridging members as described in GB 2425663 A, the subject matter of which is incorporated herein by reference, is used to retain the wedge radially.

It will be appreciated that embodiments of the invention have been described above by way of example only. The various embodiments may be used on their own or in any appropriate combination. For example, a mixture of different wedges could be used in the same machine. Any of the wedges may be provided with a textile material between the wedge and the windings to help slide the wedge into place and/or retain the wedge after impregnation with resin. Furthermore, any of the wedges may be provided with cooling fins. The wedges may be made from any suitable material. The machine may have a different number of salient poles, in which case the angle between the two legs of a wedge may correspond to the angle between two adjacent poles. Other variations in detail will be apparent to the skilled person within the scope of the claims.

1. A rotor of a rotating electrical machine, the rotor comprising:
a plurality of salient poles;
rotor windings on the salient poles; and
a wedge configured to retain the rotor windings of two adjacent poles,
wherein the wedge extends partway through the windings in an axial direction,
the wedge comprises two legs arranged at an angle to each other, and
the wedge is configured to be slid axially in the rotor during assembly.

2. The rotor of claim 1, wherein the wedge is a single piece.

3. The rotor of claim 1, wherein the wedge has an L-shaped cross-section.

4. The rotor of claim 1, wherein the wedge is configured to be inserted axially into the rotor.

5. The rotor of claim 1, wherein the wedge has a first leg which abuts rotor windings on a first salient pole and a second leg which abuts rotor windings on a second, adjacent salient pole, and wherein the first leg and the second leg are substantially planar.

6. (canceled)

7. The rotor of claim 5, wherein the wedge in its free state has an angle between the first leg and the second leg substantially equivalent to an angle between two adjacent salient poles.

8. (canceled)

9. The rotor of claim 8, wherein the wedge is arranged to have an angle between the first leg and the second leg which is substantially fixed in the free state, during assembly and/or in the assembled rotor.

10. The rotor of claim 9, wherein an axial cooling channel is defined between the first leg and the second leg.

11. The rotor of claim 5, wherein the wedge is of a design which does not include a bracing member between the first leg and the second leg.

12. The rotor of claim 1, wherein the wedge is not elastically deformable.

13. The rotor of claim 1, wherein the wedge is not subjected to a bending moment when the rotor is stationary.

14. The rotor of claim 1, wherein the salient poles comprise pole tips and the wedge is configured to slide beneath the pole tips of two adjacent poles.

15. The rotor of claim 1, wherein the wedge has insufficient elastic deformability for it to be inserted radially into the rotor between pole tips of adjacent salient poles.

16. The rotor of claim 14, wherein at least one of the pole tips has a recess which allows a wedge to be inserted radially into the rotor and then slid axially to a position under a pole tip without a recess.

17. The rotor of claim 1, further comprising a compressible sheet between the wedge and the windings, wherein the compressible sheet is arranged to absorb resin during an impregnation process.

18. (canceled)

19. The rotor of claim 1, wherein the salient poles comprise winding supports for supporting a radially inward side of the rotor windings;
a gap is provided between the winding supports of two adjacent salient poles;
the wedge comprises an extension which extends into the gap between the winding supports of two adjacent salient poles; and
the extension engages with the winding supports to retain the wedge radially.

20. (canceled)

21. The rotor of claim 1, comprising a plurality of wedges at spaced locations in an axial direction for retaining the windings of two adjacent poles.

22. The rotor of claim 21, wherein at least one of the wedges is of a different type from at least one of the other wedges.

23. The rotor of claim 21, wherein at least one of the wedges is configured to be inserted radially into the rotor.

24. (canceled)

25. A method of assembling a rotor for a rotating electrical machine, the rotor comprising a plurality of salient poles, rotor windings on the salient poles and a wedge for retaining the windings of two adjacent poles, the method comprising:
providing a wedge comprising two legs arranged at an angle to each other; and
sliding the wedge axially in the rotor to a position where the wedge extends partway through the windings in an axial direction.
